(19) United States
(12) Patent Application Publication
(10) Pub. No.: US 2016/0141975 A1
(43) Pub. Date: May 19, 2016

(54) Capacitor Drop Power Supply

(71) Applicant: Dialog Semiconductor Inc., Campbell, CA (US)

(72) Inventor: Andrey Malinin, Fort Collins, CO (US)

(21) Appl. No.: 14/542,314

(22) Filed: Nov. 14, 2014

(51) Int. Cl. H02M 7/06

(52) U.S. Cl. CPC H02M 7/06

(57) ABSTRACT

A capacitor drop power supply is provided where excess charge is damped into a low impedance switch, avoiding the dissipation of extra energy seen in current designs. Also, because the excess charge is not dissipated, it then becomes available for when a load is applied thus increasing the efficiency of the power supply. The present disclosure therefore provides various advantages compared with existing capacitor drop power supplies. It provides the simplicity and low cost of a capacitor drop power supply, but with an efficiency that is equivalent or superior to that of a switching mode power supply.

### TECHNICAL FIELD

The present disclosure relates to a capacitor drop power supply circuits and power supply methods.

### BACKGROUND

A capacitor drop power supply provides a simple and low cost way for converting an AC voltage such as a mains voltage to a DC supply voltage, which may be used for driving a load. Instead of providing a transformer to step down the voltage, a capacitor (known as a drop capacitor) is coupled in series with the AC supply and acts to step down the voltage. Power supplies of this type are used in various contexts, for example as auxiliary supplies for moter drivers and in electrical appliances.

An illustrative schematic of a typical capacitor drop power supply is shown in FIG. 1. An AC power supply 100 provides an AC voltage which is converted to a DC voltage across output terminals 102, 104. Diodes 106 (D1) and 108 (D2) provide half-wave rectification of the AC waveform and the drop capacitor 110 (C1) steps down the voltage. A zener diode 112 (D3) is provided which regulates the output voltage, while a filter capacitor 114 (C2) reduces ripple in the output voltage. The circuit of FIG. 1 could also be modified so that the positive rail is connected to the AC line.

FIG. 2 illustrates a similar circuit with full wave rectification, provided by rectifier diodes 200, 202, 204, 206 (D1, D2, D4, D5) arranged in a bridge formation. The other components are similar to those in FIG. 1 and are illustrated with corresponding reference numerals. The circuit of FIG. 2 could be used if the negative rail does not have to be connected to the AC line.

Despite the low cost and simplicity of a drop capacitor power supply, the practical implementation of such a circuit is limited by a number of problems.

Firstly, the circuit must be designed to deal with a range of voltages around a nominal output voltage value that is to be output by the circuit. The drop capacitor must have sufficient capacitance to deliver enough power at a minimum voltage in the range. Therefore, at the nominal voltage the drop capacitor delivers more current than is needed and so excess energy is dissipated in the zener diode.

Also, power dissipation does not depend on the load. If the load does not consume energy, the energy will be dissipated in the zener diode. This restricts use of the capacitor drop power supply in applications with low standby power consumption requirements.

The drop capacitor has lower impedance for higher harmonics of the AC line frequency. If a capacitor drop power supply is coupled with a supply that has significant high frequency harmonic content, the power dissipation in the zener diode and other components could exceed predicted values resulting in circuit overheating and failure.

### SUMMARY

It is therefore desirable to provide a non-isolated power supply topology which will outperform competitive solutions in cost and performance.

According to a first aspect of the disclosure there is provided a capacitor drop power supply circuit for coupling with an input AC supply and providing a DC output voltage, said circuit comprising a drop capacitor, and a rectifier circuit comprising a switch that is selectively operable to regulate the DC output voltage.

Optionally, the capacitor drop power supply circuit comprises:

i) a rectifier circuit with an input and an output;

ii) a drop capacitor provided between a first AC supply terminal and the input of the rectifier circuit; and

iii) a filter capacitor provided between the output of the rectifier circuit and a second AC supply terminal;

iv) wherein the rectifier circuit comprises:

v) a diode coupled between the drop capacitor and the rectifier circuit output;

vi) a switch connected between the rectifier circuit input and the second AC supply terminal; and

vii) a controller which can selectively operate the switch to regulate an output voltage of the rectifier circuit.

When one component is provided between other components, this can be via a direct coupling or alternatively the coupling may be indirect, in other words the provision of additional interposing components is not precluded.

Optionally, switching a rectifier circuit to regulate the DC output voltage is achieved using a semiconductor switching element.

Optionally, the rectifier circuit provides a half wave rectified output.

Optionally, the rectifier circuit provides a full wave rectified output.

Optionally, the controller provides trailing edge control.

Optionally, the controller provides leading edge control.

According to a second aspect of the disclosure there is provided a power supply method comprising converting an AC supply to a DC output by coupling the AC supply with a drop capacitor; and selectively switching a rectifier circuit to regulate the DC output voltage.

Optionally, the rectifier circuit comprises an input and an output, a diode coupled between the drop capacitor and the rectifier circuit output, a switch connected between the rectifier circuit input and the second AC supply terminal, and a controller; and the method comprises:

i) providing a drop capacitor between a first AC supply terminal and the input of the rectifier circuit;

ii) providing a filter capacitor provided between the output of the rectifier circuit and a second AC supply terminal; and wherein

iii) the controller selectively operates the switch to regulate an output voltage of the rectifier circuit.

Optionally, the switch comprises a semiconductor switching element.

Optionally, the rectifier circuit provides a half wave rectified output.

Optionally, the rectifier circuit provides a full wave rectified output.

Optionally, the controller provides trailing edge control.

Optionally, the controller provides leading edge control.

### BRIEF DESCRIPTION OF THE DRAWINGS

The disclosure will be described below, by way of example only, with reference to the accompanying drawings, in which:

FIG. 1 shows an existing capacitor drop power supply circuit, with half wave rectification;

FIG. 2 shows an existing capacitor drop power supply circuit, with full wave rectification;

FIG. 3 shows a capacitor drop power supply circuit in accordance with an embodiment of the disclosure, implementing half wave rectification;

FIG. 4 shows a capacitor drop power supply circuit according to an embodiment of the disclosure which is provided with a controller providing trailing edge current control;

FIG. 5 shows various waveforms that illustrate the operation of the circuit of FIG. 4;

FIG. 6 shows various waveforms that illustrate the operation of the circuit of leading edge control for the capacitor drop power supply circuit of FIG. 3;

FIG. 7 shows a capacitor drop power supply circuit according to an embodiment of the disclosure which is provided with a controller providing leading edge current control;

FIG. 8 shows various waveforms that illustrate the operation of the circuit of FIG. 7; and

FIG. 9 shows a capacitor drop power supply circuit in accordance with an embodiment of the disclosure, implementing full wave rectification.

### DESCRIPTION

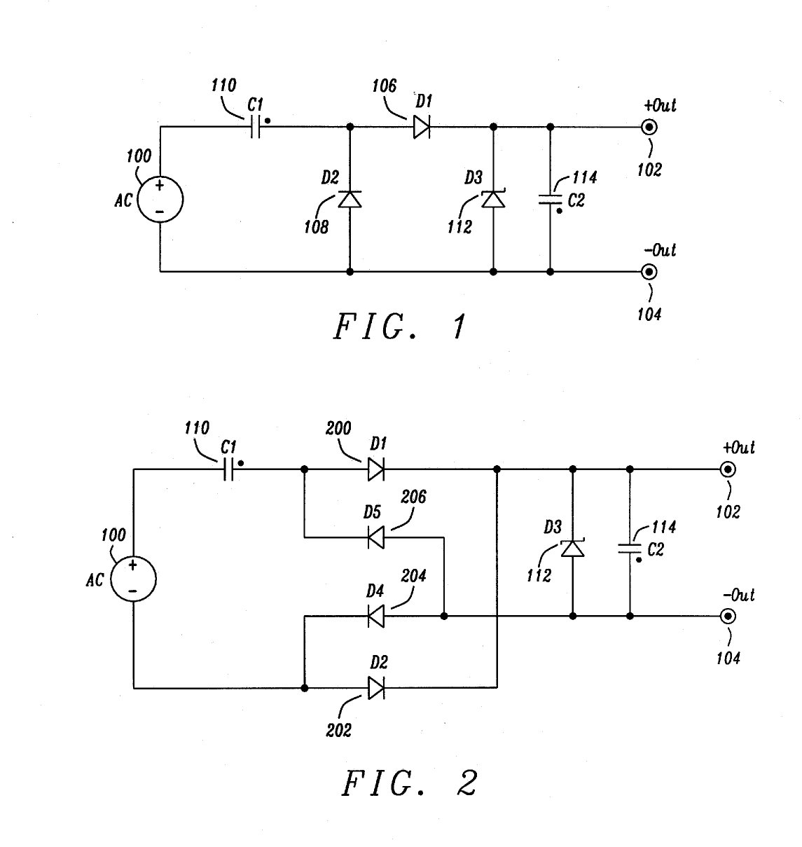

In an existing capacitor drop power supply, all the energy stored in the drop capacitor is either consumed by the load or dissipated in the zener diode. Referring to the circuit of FIG. 1, during a positive half cycle of the AC supply 100 AC current passes through the drop capacitor 110 and rectifier diodes 106, 108 and to the parallel combination of the output and filter capacitor 114. The filter capacitor 114 is charged by the current flow and when the charge reaches a certain threshold the zener diode 112 reaches its breakdown voltage and starts to permit flow in its reverse direction. Excess current is dissipated in the zener diode 112 while the filter capacitor 114 remains charged and the output voltage across the terminals 102, 104 remains constant. During this time the drop capacitor 110 is charged and its voltage increases. Then, in a negative half cycle of the AC supply 100, the drop capacitor 110 is discharged through the forward biased zener diode 112.

The present disclosure provides a capacitor drop power supply circuit where excess charge is damped into a low impedance switch. The low impedance switch is provided in place of a zener diode and so the dissipation of extra energy is avoided.

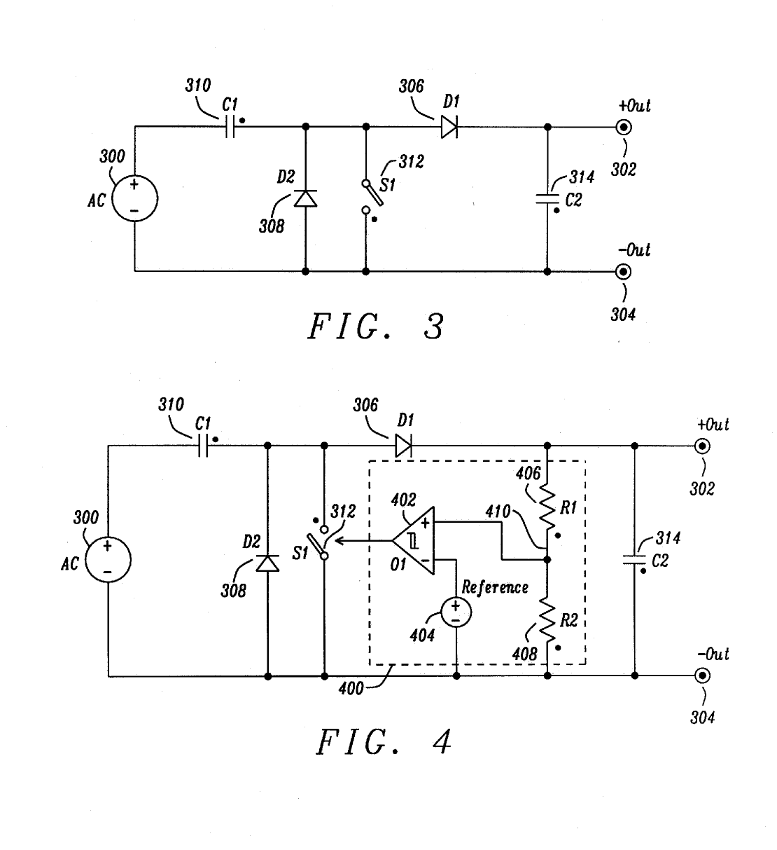

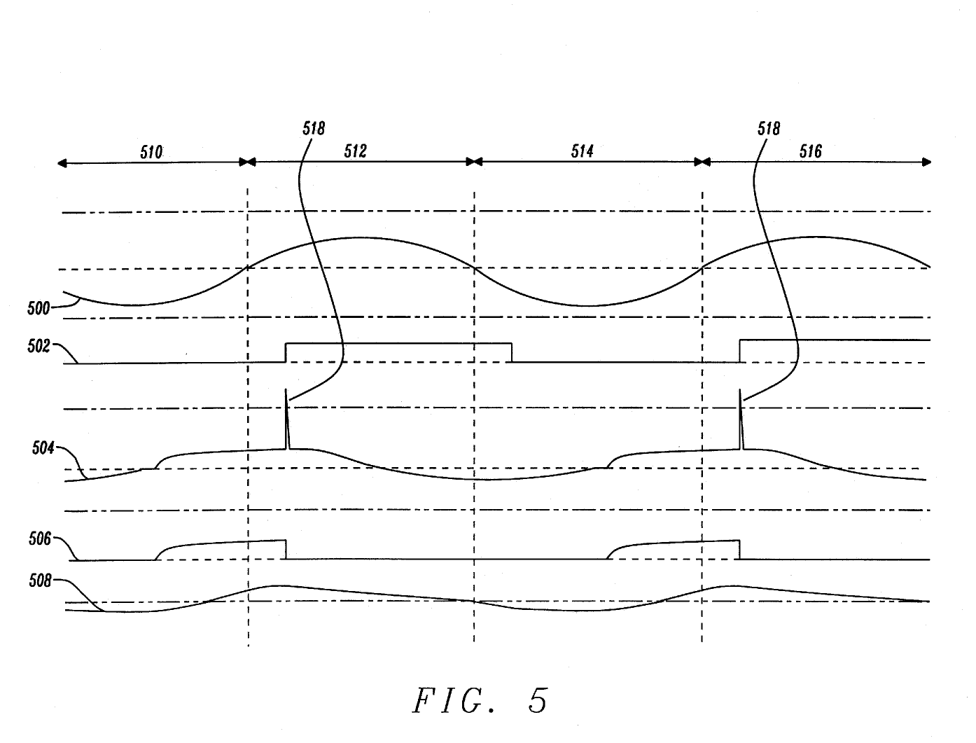

An embodiment of the disclosure is schematically illustrated in FIG. 3, in which half wave rectification is provided. Here, an AC power supply 300 provides an AC voltage which is converted to a DC voltage across output terminals 302, 304. Diodes 306 (D1) and 308 (D2) provide half-wave rectification of the AC waveform and the drop capacitor 310 (C1) steps down the voltage. The drop capacitor 310 may be any suitable type of capacitor, such as a ceramic capacitor, film, paper or AC electrolytic type for example. It may optionally be X-rated. Other types of capacitor may be used. A filter capacitor 314 (C2) reduces ripple in the output voltage. The filter capacitor 314 must have a relatively large capacitance and so may for example be an electrolytic or aluminum polymer capacitor, although other types may be used. A switch 312 (S1) is provided which is controlled to provide a voltage regulation function.

During a positive half cycle of the AC supply 300, AC current passes through the drop capacitor 310 and rectifier diodes 306, 308 and to the parallel combination of the output and filter capacitor 314. The filter capacitor 114 is charged by the current flow and when the charge reaches a certain threshold the switch 312 is closed. Excess current is then damped in the switch 312 while the filter capacitor 314 remains charged and the output voltage across the terminals 302, 304 remains constant. During this time the drop capacitor 310 is charged and its voltage increases. The switch 312 remains closed throughout the course of the time when excess energy is being provided by the drop capacitor 310 and filter capacitor 314, so that the excess energy does not get dissipated. Then, when the capacitors 310, 314 are no longer supplying excess energy, the switch opens again. The switch may open again during the positive half cycle or during the negative half cycle.

Because the excess charge is not dissipated, it then becomes available for when a load is applied thus increasing the efficiency of the power supply as compared with a topology in which energy is dissipated in a zener diode.

A controller is provided to operate the switch. The present disclosure is not limited to any one type of controller, but as an example a switch controller comprises a comparator that provides trailing edge current control to the rectifier diode 306. An embodiment of this is illustrated in FIG. 4.

In the embodiment of FIG. 4, a controller 400 is provided for the circuit of FIG. 3. The controller 400 provides a control signal for changing the state of switch 312 and comprises a comparator 402 with hysteresis that compares a reference voltage 404 with the output of a resistor divider which provides an output voltage at 410 that is a fraction of the voltage across the filter capacitor 314, the fraction being specified by the values of a first resistor 406 (R1) and a second resistor 408 (R2). Therefore, when the voltage across the filter capacitor 314 reaches a certain threshold, the comparator 402 changes state and the switch 312 is closed so that the output voltage remains constant.

This type of the controller provides trailing edge current control to the rectifier diode 306. FIG. 5 shows various waveforms that illustrate the operation of the circuit of FIG. 4. The figure shows the AC voltage 500, the comparator output 502, drop capacitor current 504, rectifier diode current 506 (flat portion is zero current) and output voltage ripple 508.

FIG. 5 shows the variation of these components during AC cycles comprising positive half cycle portions 512, 516 and negative half cycle portions 510, 514. The comparator output 502 opens the switch 312 when it goes low and closes the switch 312 when it goes high. As shown by the illustrated portion 512, at the start of a positive half cycle the comparator 400 output is low so the switch 312 is open. AC current passes through the drop capacitor 310, rectifier diodes 306, 308 and the parallel combination of the output and filter capacitor 314. When the voltage across the filter capacitor 314 reaches a certain value, the comparator 400 changes state and closes the switch 312 so that excess charge is damped by the switch 312. At this point there is a spike 518 in the drop capacitor current 504 and the current through the rectifier diode 306 drops.

To illustrate the advantages of the circuit of FIG. 4 as compared with the circuit of FIG. 1, we consider a specific example. Say we have a 12V 1 W peak supply with 0.1 W standby power consumption for 220 VAC 50 Hz mains.

With the conventional capacitor drop power supply design of FIG. 1, for a required output current of 84 mA and allowing for 10 % ripple output, the filter capacitor 114 should have a value of 1400 uF. The voltage swing is (622V−12V)=610V. Therefore the drop capacitor 110 should have a capacitance of 83 mA*20 ms/610=2.76 uF. If we factor a 20% margin for low line and rounding to standard value gives 3.3 uF.

During normal operation this capacitor will deliver 100 mA current. The zener diode should be able to dissipate energy at a full power value: 12V*0.1 A=1.2 W. The efficiency at full load is 83% and in standby mode is 8.3%.

A simulation was carried out which took into account factors including power dissipation of the rectifier diodes 106, 108 and it was found that a full load efficiency of 74% was achieved.

For the improved design, according to the embodiment of FIG. 4, the calculations are the same except instead of power dissipation to the zener diode we need to use switching loss in the switch 312. The energy dissipated to the switch is F*CV²/2=50*3.3 uF*(12V)²/2=52 mW. The predicted efficiency in this case will be 95% at peak load and 66% in standby mode. A simulation was carried out which took into account factors including power dissipation of the rectifier diodes 306, 308 and it was found that a full load efficiency of 85% was achieved. This compares favorably with the efficiency of a switched mode power supply.

Use of trailing edge control has a disadvantage. The theoretical efficiency is limited by energy dissipated in the switch during turn on. These losses are indicated as spikes on the capacitor current waveform.

By using more complicated leading edge control it is possible to implement zero voltage turn on soft switching. The theoretical efficiency of this scheme is 100% as there is no discharge of the capacitor and no energy losses associated with it.

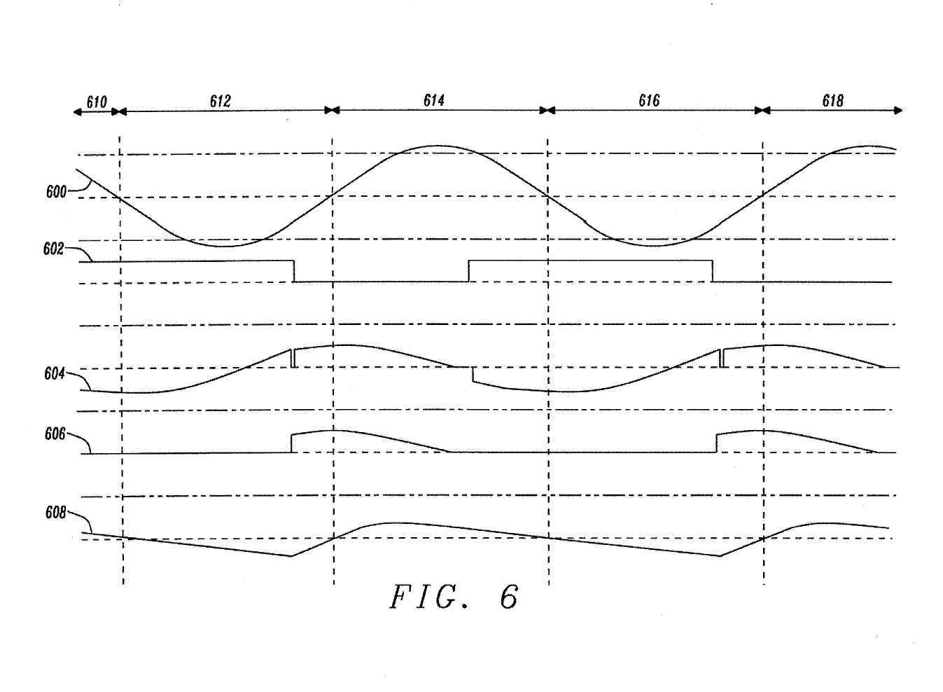

FIG. 6 shows various waveforms that illustrate the operation of the circuit with a leading edge controller. The figure shows the AC voltage 600, switch control voltage 602 (applied to the switch 312), drop capacitor current 604, rectifier diode current 606 and output voltage ripple 608. FIG. 6 shows the variation of these components during positive half cycle portions 610, 614, 618 and negative half cycle portions 612, 616. As can be seen in these waveforms in comparison with those of FIG. 5, there are no current spikes so no extra energy is dissipated in the switch 312.

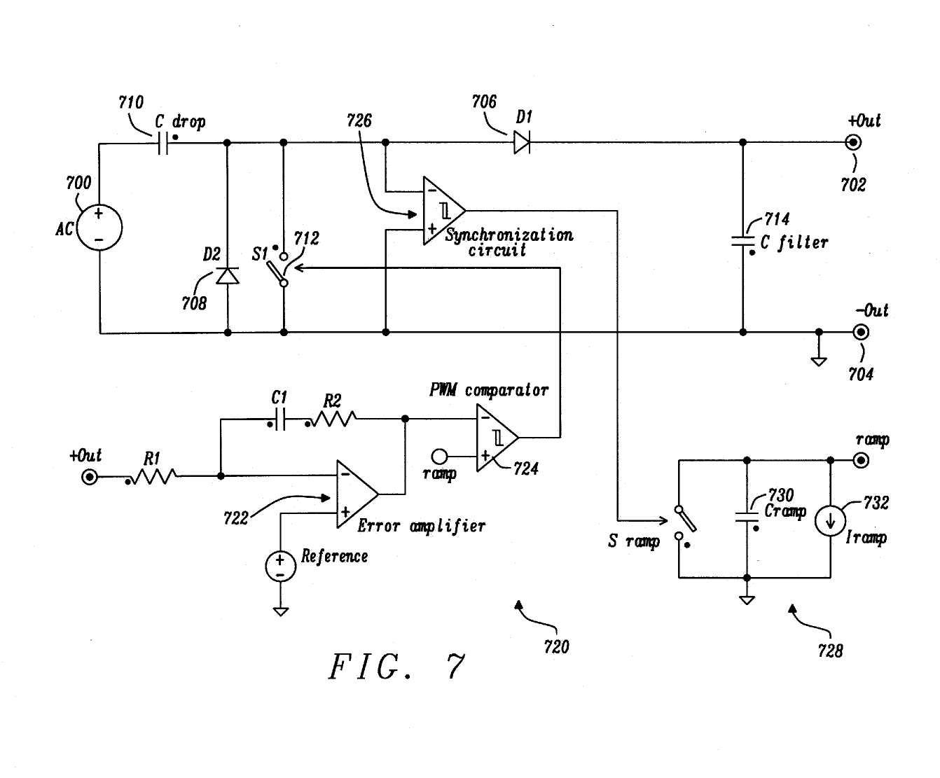

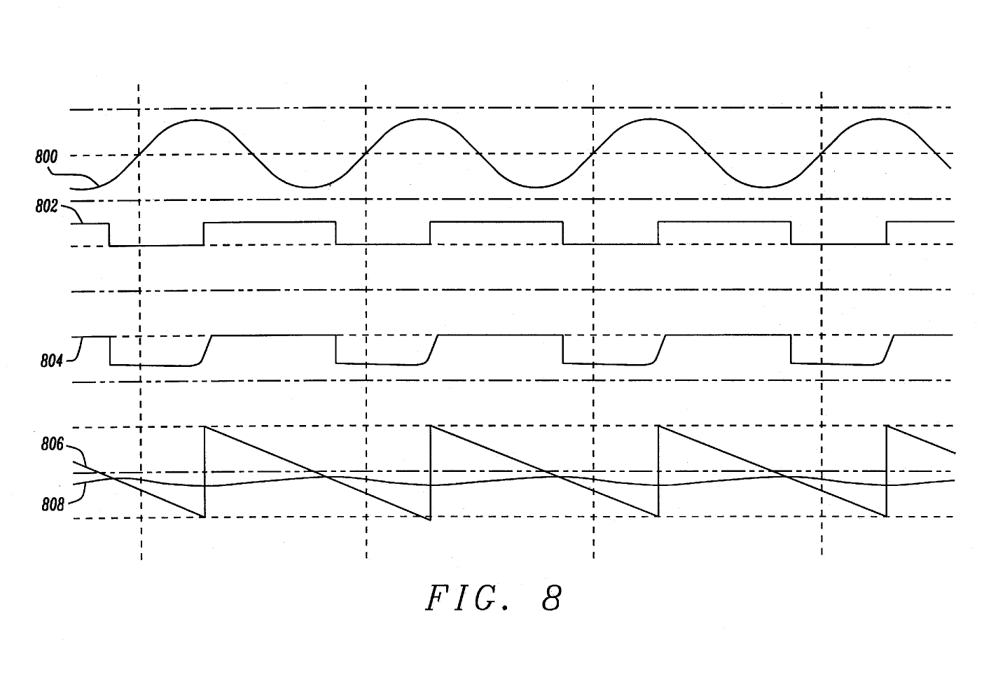

FIG. 7 illustrates an embodiment of a capacitor drop power supply circuit that provides leading edge phase control of a switch for regulation of the output voltage. An AC power supply 700 provides an AC voltage which is converted to a DC voltage across output terminals 702, 704. Diodes 706 (D1) and 708 (D2) provide half-wave rectification of the AC waveform and the drop capacitor 710 (Cdrop) steps down the voltage. A switch 712 (S1) is provided which regulates the output voltage in a similar manner to that described above with reference to FIGS. 3-5. In this embodiment a leading edge controller 720 is provided for the switch 712. The leading edge controller 720 comprises an error amplifier 722, a pulse width modulation (PWM) comparator 724, synchronisation circuit 726 and ramp generator 728.

After AC input voltage passes its positive peak, the voltage on the input of the synchronization circuit 726 (diode 708) starts to reduce. When this voltage becomes negative, diode 708 becomes forward biased and can start to conduct the current. At the same time the synchronization circuit 726 resets the voltage on the ramp capacitor 730 (Cramp). This marks the beginning of the switching cycle. A current source 732 discharges the ramp capacitor 730, creating a negative slope.

Because the voltage of the ramp 728 is applied to a positive input of the PWM comparator 724, its output will switch into a high state and the switch 712 will be turned on. Current from the drop capacitor 710 will go through the low impedance of the switch 712 without significant power dissipation.

After the AC input voltage passes its negative peak, current through the drop capacitor 710 will reverse direction, but still goes into the switch 712.

When the ramp voltage crosses the output voltage of the error amplifier 722, the PWM comparator 724 will change state and will turn switch 712 off. Current though the drop capacitor 710 will not be shorted by S1 and will flow to the load through diode 706 until the AC voltage reaches its positive peak.

If the output voltage of the error amplifier 722 is lower, the time during which current flows to the load is less, so output voltage will reduce. If the error amplifier 722 output is higher, the output voltage will increase. This function combined with the inverting function of the error amplifier 722 will create the negative feedback. To ensure stable feedback a compensator circuit should be employed, ideally a type II proportional-integral (PI) compensator.

FIG. 8 illustrates further details of the operation of the circuit of FIG. 7 over several AC cycles. The figure illustrates the AC waveform 800, switch control signal 802, syncronization control input 804, ramp voltage 806, and error amplifier output 808.

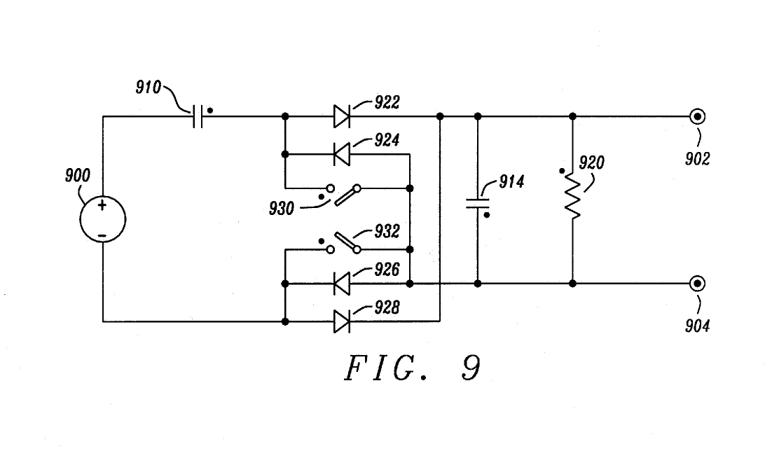

FIGS. 3-8 illustrate embodiments in which half wave rectification is provided. However similar principles can be applied for full wave rectification. A capacitor drop power supply according to an embodiment which provides full wave rectification is illustrated in FIG. 9. Here, an AC power supply 900 provides an AC voltage which is converted to a DC voltage across output terminals 902, 904. A filter capacitor 914 and resistor 920 are provided in parallel with the output. Full wave rectification is provided by rectifier diodes 922, 924, 926, 928 which are selectively connected via a first switch 930 and a second switch 932.

The present disclosure therefore provides various advantages compared with existing capacitor drop power supplies. The various embodiments of the disclosure provide the simplicity and low cost of a capacitor drop power supply, but with an efficiency that is equivalent or superior to that of a switching mode power supply. Furthermore, because extra energy is not dissipated in the power supply of the present disclosure, lower capacitor impedance will not cause extra power loss meaning that the present disclosure allows for the use of low cost capacitive drop techniques with mains supplies that have a high harmonic content.

Therefore the present disclosure provides power supplies that can close the market niche between capacitor drop and switched mode power supplies.

Various modifications and improvements can be made to the above without departing from the scope of the disclosure. While aspects of the invention have been described with reference to exemplary embodiments, it is to be clearly understood by those skilled in the art that the invention is not limited thereto.

What is claimed is:

1. A capacitor drop power supply circuit for coupling with an input AC supply and providing a DC output voltage, said circuit comprising a drop capacitor, and a rectifier circuit comprising a switch that is selectively operable to regulate the DC output voltage.

2. The capacitor drop power supply circuit of claim 1, comprising:
a rectifier circuit with an input and an output;
a drop capacitor provided between a first AC supply terminal and the input of the rectifier circuit; and
a filter capacitor provided between the output of the rectifier circuit and a second AC supply terminal;
wherein the rectifier circuit comprises:
a diode coupled between the drop capacitor and the rectifier circuit output;
a switch connected between the rectifier circuit input and the second AC supply terminal; and
a controller which can selectively operate the switch to regulate an output voltage of the rectifier circuit.

3. The capacitor drop power supply circuit of claim 1, wherein the switch comprises a semiconductor switching element.

4. The capacitor drop power supply circuit of claim 1, wherein the rectifier circuit provides a half wave rectified output.

5. The capacitor drop power supply circuit of claim 1, wherein the rectifier circuit provides a full wave rectified output.

6. The capacitor drop power supply circuit of claim 2, wherein the controller provides trailing edge control.

7. The capacitor drop power supply circuit of claim 2, wherein the controller provides leading edge control.

8. A power supply method comprising converting an AC supply to a DC output by coupling the AC supply with a drop capacitor; and selectively switching a rectifier circuit to regulate the DC output voltage.

9. The method of claim 8, wherein the rectifier circuit comprises an input and an output, a diode coupled between the drop capacitor and the rectifier circuit output, a switch connected between the rectifier circuit input and the second AC supply terminal, and a controller; and the method comprises:
providing a drop capacitor between a first AC supply terminal and the input of the rectifier circuit;
providing a filter capacitor provided between the output of the rectifier circuit and a second AC supply terminal; and wherein
the controller selectively operates the switch to regulate an output voltage of the rectifier circuit.

10. The method of claim 8, wherein switching a rectifier circuit to regulate the DC output voltage is achieved using a semiconductor switching element.

11. The method of claim 8, wherein the rectifier circuit provides a half wave rectified output.

12. The method of claim 8, wherein the rectifier circuit provides a full wave rectified output.

13. The method of claim 9, wherein the controller provides trailing edge control.

14. The method of claim 9, wherein the controller provides leading edge control.
